(19) United States
(12) Patent Application Publication
(10) Pub. No.: US 2024/0281914 A1
(43) Pub. Date: Aug. 22, 2024

(54) METHOD AND APPARATUS FOR CROSS-REFERENCING IMPORTANT IP RELATIONSHIPS

(71) Applicant: Black Hills IP Holdings, LLC, Minneapolis, MN (US)

(72) Inventors: Steven W. Lundberg, Edina, MN (US); Janal M. Kalis, Minneapolis, MN (US)

(21) Appl. No.: 18/369,715

(22) Filed: Sep. 18, 2023

Related U.S. Application Data
(63) Continuation of application No. 17/025,847, filed on Sep. 18, 2020, now Pat. No. 11,798,111.
Application No. 17/025,847 is a continuation of application No. 14/750,559, filed on Jun. 25, 2015, now Pat. No. 10,810,693.
Application No. 14/750,559 is a continuation of application No. 14/536,320, filed on Nov. 7, 2014, now abandoned.
Application No. 14/536,320 is a continuation of application No. 11/915,718, filed on Jul. 14, 2008, now abandoned.
(60) Provisional application No. 60/685,759, filed on May 27, 2005.

(51) Int. Cl. G06Q 50/18; G06F 16/242; G06Q 10/10

(52) U.S. Cl. CPC G06Q 50/184; G06F 16/242; G06Q 10/10

(57) ABSTRACT

This document discusses, among other things, a system and method to provide cross-referencing of important IP relationships. The system comprising software executing on a computing platform for displaying relationships between various domains of IP information selected from the group of claims, prosecution history, products, concepts or art.

### TECHNICAL FIELD

This patent document pertains generally to data collection and presentation, and more particularly, but not by way of limitation, to a method and apparatus for cross-referencing important intellectual property relationships.

### BACKGROUND

In a patent application, claims define the scope of an issued patent, and consequently, the claims also define the scope and breadth of the associated intellectual rights or property. A system and method to concisely catalog and describe pending and issue claims may assist a practitioner when providing advice to a client, drafting well-formed claims, and avoiding unnecessary costs during prosecution.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a diagram illustrating an example embodiment of a hierarchy used to display client and matter information in a patent information warehouse system.

FIG. 2 is a display screen illustrating an example embodiment of a home node.

FIG. 3 is a display screen illustrating an example embodiment of a client child node and a product space grandchild node.

FIG. 4 is a display screen illustrating an example embodiment of a client child node and a concept ontology grandchild node.

FIG. 5 is a display screen illustrating an example embodiment of a client child node and a claims grandchild node.

FIG. 6 is a display screen illustrating an example embodiment of a client child node and a references grandchild node.

FIG. 7 is a display screen illustrating an example embodiment of a matter child node and a claims grandchild node.

FIG. 8 is a display screen illustrating an example embodiment of a matter child node and a prosecution grandchild node.

FIG. 9 is a display screen illustrating an example embodiment of a matter child node and a prosecution grandchild node.

FIG. 10 is a display screen illustrating an example embodiment of a matter child node and a product space grandchild node.

FIG. 11 is a display screen illustrating an example embodiment of a matter child node and a concepts grandchild node.

FIG. 12 is a display screen illustrating an example embodiment of a matter child node and a cited references grandchild node.

FIG. 13 is a flowchart illustrating a method of cataloging and providing intellectual property information, in accordance with an example embodiment.

FIG. 14 is a diagram illustrating a client-server networked environment, in accordance with an example embodiment.

FIG. 15 is a block diagram illustrating a machine in the example form of a computer system, within which a set or sequence of instructions for causing the machine to perform any one of the methodologies discussed herein may be executed.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated.

In various embodiments, one or more of the features described below are included to provide a system or method for cross-referencing important intellectual property relationships.

### The High Level Purposes of CoreIP are as Follows:

Map relationships between the following data:
   Claim Space—this is the “atomic” level of IP protection. Claims define what the IP exclusivity is. Claims are the core of patents. While claims belong to patents, we are tracking first and foremost claims, and only secondarily the patents these claims belong to.
      Claim space includes claims as filed, as amended during prosecution, and as allowed and issued.
   Product space—this is the “space” that the business people live in. They think in terms of products and services, product lines, product features, product functions. We want CoreIP to be able to show business people what they have for IP protection with respect to this space, so that they can quickly understand where they stand on IP protection. Also, this capability will allow patent attorneys to see the strategic value of the protection they are getting for the client.
      Claims are mapped to the Product space, so that a user can see which if any claims cover which products/features
   Concept Space. Claims are made up of concepts. There are Common Concepts and Specialization Concepts
      A concept ontology is provided, having a hierarchy with nodes.
      Claims are indexed/mapped using the ontology
      Claims as a whole are mapped to at least one (or more) of the narrowest nodes in the ontology that is broader than the breadth of the claim.
      A Claimed Concept space can be filtered to eliminate patents that are not of a scope of interest
   References Space. This is the space of prior art. In particular, the references space includes prior art patents or other prior art teachings, such as prior products or publications.
      References are mapped to claims
      References can also be mapped to the concept space
   Prosecution History Space. The prosecution space is defined by the prosecution history. In this context, the prosecution space focuses on the history of filed claims, claim amendments, prior art citation and patent office rejections/objections, and attorney arguments.
      Rejections/rejections are mapped to claims
      attorney arguments are mapped to claims and references
Using the above indexes and mappings, attorneys will be able to do the following:
   Find all other instances of a reference being cited or argued in the same or another case
   Continuously understand the relationship between the Product Space and the Claims
   Quickly understand the scope of claims by looking at the Concept Space map for a claim
   Quickly find claims of a particular scope by searching and filtering in the Claimed Concept space
   Cross reference Claimed Concept space to the Product Space
   Find References that have been cited against concepts in a particular branch of the Concept space
   View a summary/compact view of the file history space to quickly

### Sets of Claims

The simplest way to track and display claims is to model it as follows:
claims are tracked as a “Set”
an application is filed with an Initial Set of claims (“claims as filed”)
if a Set of claims is amended, it is amended on a certain Date
the Set of allowed claims has an “allowance date”
a Set of issued claims has an “issue date”

So, claims are grouped in Sets, and each Set has a Date associated with it, and each Date can have a Date Type, like “Filed”, “Preliminary Amendment”, “Amendment”, “Allowed”, “Issued”

Thus, we have: Claims in Sets and each Set has a Date and each Date has a Date Type.

### Amendment Status of Claims in a Set

Now, for each Claim in each Set, we want to be able to assign an Amendment Status.

The Amendment Status's are as follows:
Filed
Amended-<number> (for example: Amended-1, Amended-2, etc. . . . (allow up to 20 for a number)
Cancelled
New

### Examination Status of Claims in a Set

Now, for each Claim in each Set, we also want to be able to assign an Examination Status.

The Amendment Status's are as follows:
Not Examined
Rejected
Objected to
Allowed
Restricted Out

### Prior Art Cited Against of Claims in a Set

Now, for each Claim in each Set, we also want to be able to track Prior Art Cited against each claim.

The Prior Art Cited for each claim includes the following:
Identify Patent cited
Reason Claim Rejected
   take this text from patent office paperwork

### Arguments Made in Favor of Patentability

In addition, for each claim, we want to keep track of:
all arguments made for patentability with respect to the claim; AND
all arguments made for patentability with respect to a particular prior art Reference

In an embodiment, information describing patent applications and related information is displayed within one or more screens on a computer display. The screens may, for example, be child screens in a framed web presentation. In an embodiment, navigational links are provided, such as by tabs at the top of a computer display screen. Using the navigational links or tabs, a user can view refined subsets of information.

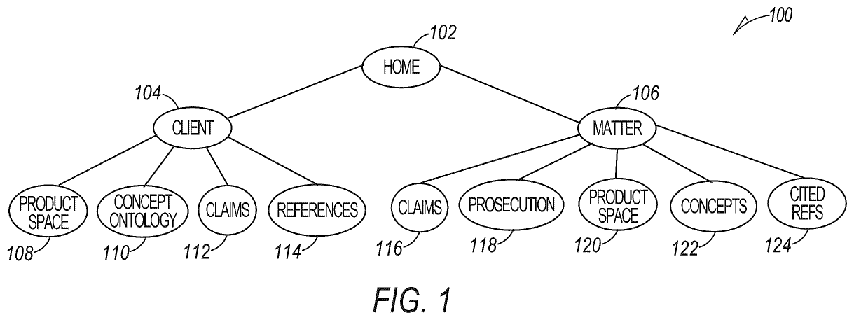

FIG. 1 is a diagram illustrating an example embodiment of a hierarchy 100 used to display client and matter information in a patent information warehouse system. In an embodiment, a home node 102, which may have the physical embodiment of a home page in a web page environment, may provide two child nodes (e.g., sub-screens), such as a client node 104 and a matter node 106. In alternative embodiments, fewer or more child nodes are available from the home node 102, such as a search node (not shown), a billing node (not shown), or a reports node (not shown).

At the client node 104, general information regarding is available, such as in a static area of a web page. In addition, one or more grandchild nodes may be provided to allow a user to drill down into further detail regarding the client node 104. In an embodiment, a product space node 108, a concept ontology node 110, a claims node 112, and a references node 114 are provided as children to the client node 104. While, in some example embodiments, the grandchildren node 108-114 may display some of the same or substantially similar information, each grandchild node is designed to display information from a particular perspective.

At the matter node 106, information related to the matter is available, such as the matter name, number, file date, client identification, file status, and the like. In an embodiment, the general information in the matter node 106 is made available using a static area of a web presentation. As with the client node 104, the matter node 106, may have, in various embodiments, one or more related grandchild nodes. In this example embodiment, the matter node 106 has a claims node 116, a prosecution node 118, a product space node 120, a concepts node 122, and a cited references node 124 as related grandchild nodes.

In various embodiments, the grandchild nodes 108-124 may additionally have related great grandchild nodes, which may provide further refined views of related information.

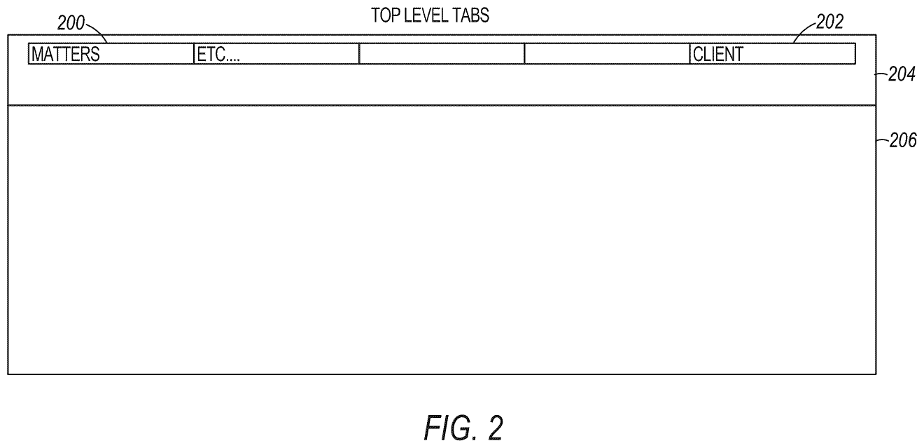

FIG. 2 is a display screen illustrating an example embodiment of a home node 102. In FIG. 2, two or more tabs are provided in a navigational area of a web page. For example, a computer display screen may be divided into two or more areas including a navigational area 204 and a content area 206. The navigational area 204 may include hypertext links, for example in the form of graphical tabs, and form input controls, for example a drop down or text input controls to input search criteria or navigate the browser display. In an example embodiment illustrated in FIG. 2, a matters tab 200 and a client tab 202 are provided to a user. Activating the matters tab 200 may load content into the content area 206.

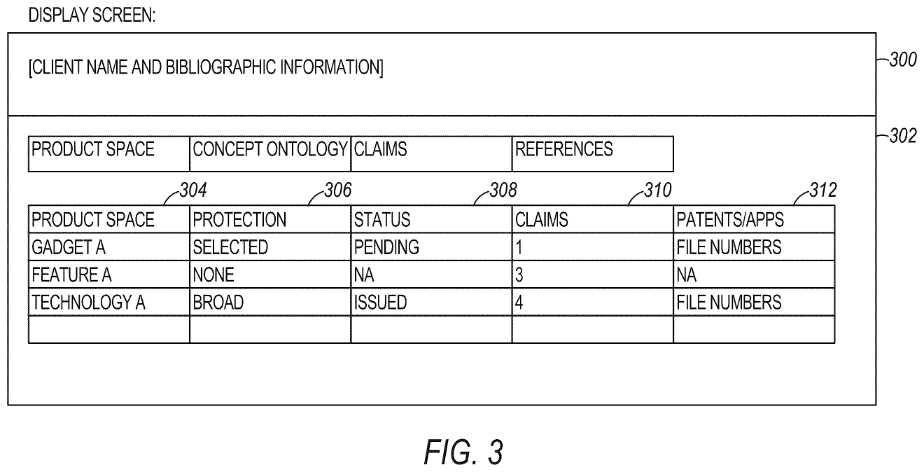

FIG. 3 is a display screen illustrating an example embodiment of a client child node 104 and a product space grandchild node 108. In FIG. 3, the displayed content may be arranged in the content area 206, as described in FIG. 2, or alternatively, the displayed content may be provided on a new web page or display. In FIG. 3, the content is arranged into two areas, a client information area 300 and a client specific content area 302. In an embodiment, the client information area 300 is a frame in HTML and remains static while the user navigates the client specific information in the client specific content area 302. The client specific information illustrated in FIG. 3 includes product space information. For example, a product space may be described using one or more attributes, such as a product space name or description 304, a product space protection indicia 306, a product space status 308, related claims 310 to each product space, and related patents or patent applications 312 to each product space. In an embodiment, a product space may have a protection indicia of selected, none, or broad. In an embodiment, a product space may have a status of pending, issued, or not available (N/A). In some embodiments, one or more claims may be listed as related to a particular product space. In some embodiments, one or more file numbers, which refer to files, such as patent applications or issued patents, may be listed as related to a particular product space.

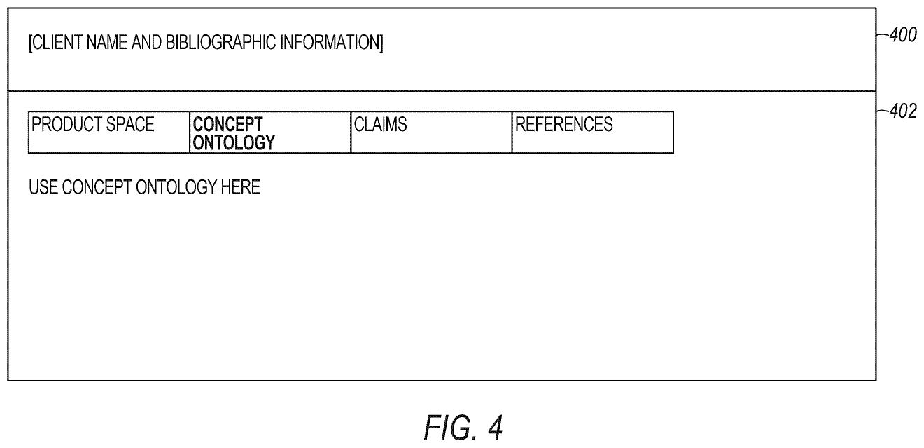

FIG. 4 is a display screen illustrating an example embodiment of a client child node 104 and a concept ontology grandchild node 110. In FIG. 4, the displayed content may be arranged in the content area 206, as described in FIG. 2, or alternatively, the displayed content may be provided on a new web page or display. In FIG. 4, as was the case in FIG. 3, the content is arranged into two areas, a client information area 400 and a client specific content area 402. In an embodiment, the client information area 400 is a frame in HTML and remains static while the user navigates the client specific information in the client specific content area 402. The client specific information illustrated in FIG. 4 includes concept ontology information. In various embodiments, the concept ontology is represented as a graph, including nodes that represent concepts, and lines or arrows connecting the nodes that represent relationships. In alternative embodiments, the concept ontology is represented in a chart or structured list, where a genus concept is arranged in a position relative to its related species concepts. For example, a concept ontology may be represented as a bulleted list, where each species is listed under its related genus.

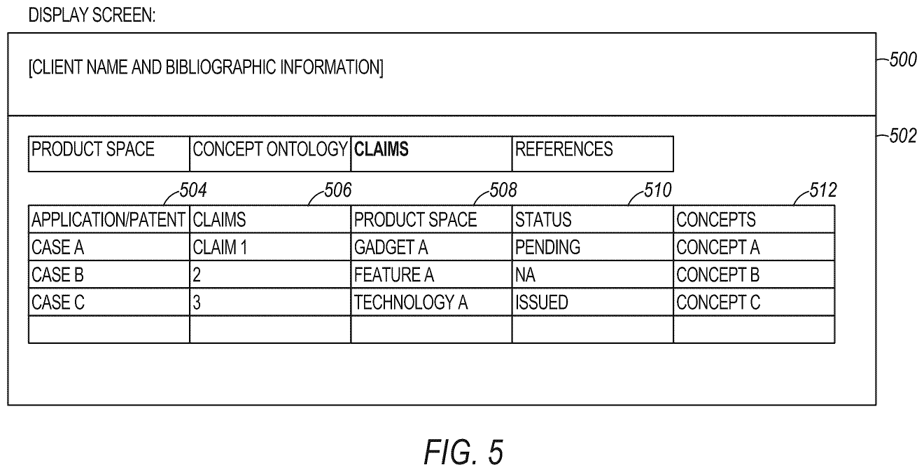

FIG. 5 is a display screen illustrating an example embodiment of a client child node 104 and a claims grandchild node 112. In FIG. 5, the displayed content may be arranged in the content area 206, as described in FIG. 2, or alternatively, the displayed content may be provided on a new web page or display. In FIG. 5, as was the case in FIG. 3, the content is arranged into two areas, a client information area 500 and a client specific content area 502. In an embodiment, the client information area 500 is a frame in HTML and remains static while the user navigates the client specific information in the client specific content area 502. The client specific information illustrated in FIG. 5 includes information about related claims. For example, related information may include an application or patent name or description 504, one or more related claims 506, a product space 508, a status 510, and related concepts 512. In an embodiment, a claim may have a protection indicia of selected, none, or broad. In an embodiment, claims may have a status of pending, issued, or not applicable (NA). In some embodiments, one or more concepts may be listed as related to a particular claim.

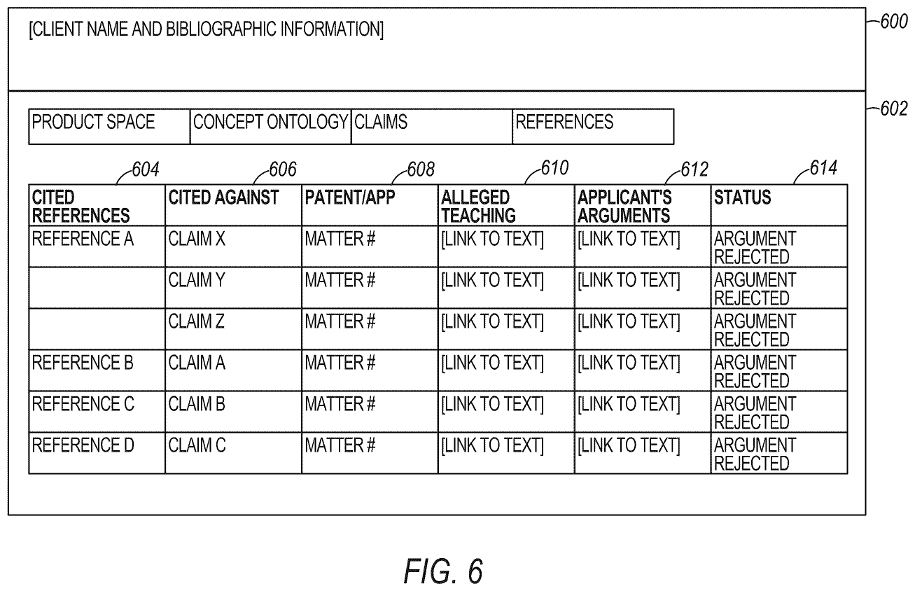

FIG. 6 is a display screen illustrating an example embodiment of a client child node 104 and a references grandchild node 114. In FIG. 6, the displayed content may be arranged in the content area 206, as described in FIG. 2, or alternatively, the displayed content may be provided on a new web page or display. In FIG. 6, as was the case in FIG. 3, the content is arranged into two areas, a client information area 600 and a client specific content area 602. In an embodiment, the client information area 600 is a frame in HTML and remains static while the user navigates the client specific information in the client specific content area 602. The client specific information illustrated in FIG. 6 includes information about related references. For example, each related reference 604 may include information showing a claim 606 the reference was cited against, a patent or application identifier 608 where the reference was used, an alleged teaching 610 of the reference, for example by an examiner in an office action, an applicant's arguments 612, for example in an attempt to overcome the alleged teaching 610, and a status 614 of the reference's use in the particular patent or application 608 for the particular claim 604. In an embodiment, a status may include an indicia that the applicant's argument was rejected, accepted, declared moot, or is pending.

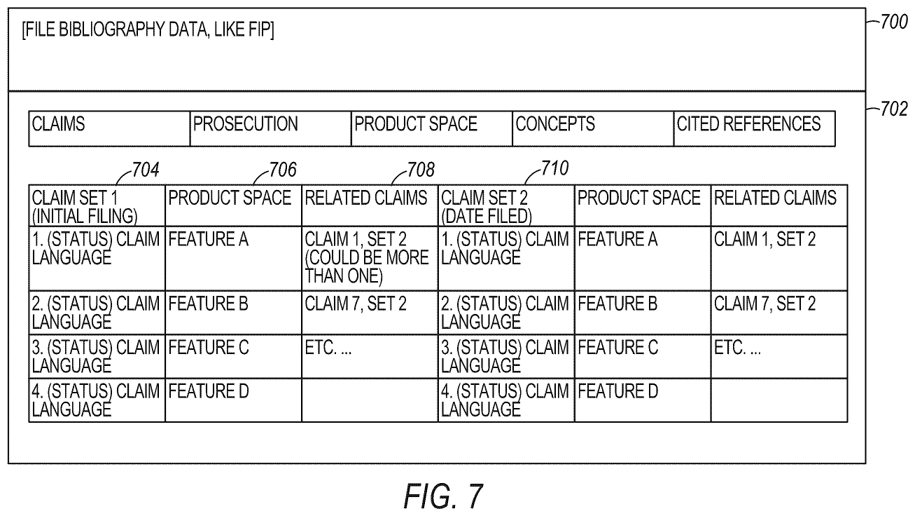

FIG. 7 is a display screen illustrating an example embodiment of a matter child node 106 and a claims grandchild node 116. In FIG. 7, the displayed content may be arranged in the content area 206, as described in FIG. 2, or alternatively, the displayed content may be provided on a new web page or display. In FIG. 7, the content is arranged into two areas, a matter information area 700 and a matter specific content area 702. In an embodiment, the matter information area 700 is a frame in HTML and remains static while the user navigates the matter specific information in the matter specific content area 702. The matter specific information illustrated in FIG. 7 includes information about related claims. For example, each related claim may be grouped by claim sets, organized by when a claim was filed, and include a status of the claim or claim set. Information about related claims may be organized, for example, to include a claim identification or description 704, a related product space 706, and related claims or claim sets 708. In an embodiment, the claim identification of description includes a date and a date type. A date type may include “Filed”, “Preliminary Amendment”, “Amendment”, “Allowed”, or “Issued” dates. In addition, in some example embodiments, additional claim sets 710 and related information are displayed and described in the same display.

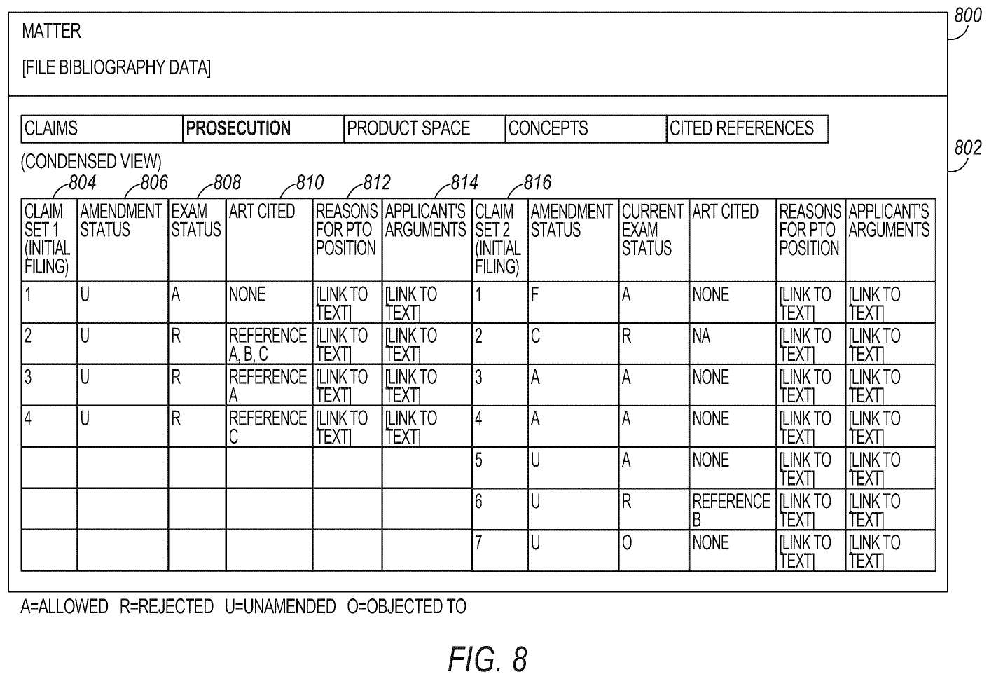

FIG. 8 is a display screen illustrating an example embodiment of a matter child node 106 and a prosecution grandchild node 118. In FIG. 8, the displayed content may be arranged in the content area 206, as described in FIG. 2, or alternatively, the displayed content may be provided on a new web page or display. In FIG. 8, the content is arranged into two areas, a matter information area 800 and a matter specific content area 802. In an embodiment, the matter information area 800 is a frame in HTML and remains static while the user navigates the matter specific information in the matter specific content area 802. The matter specific information illustrated in FIG. 8 includes information about prosecution history. In some example embodiments, two or more views are provided, such as a condensed view and an expanded view. For example, in a condensed view, such as the one illustrated in FIG. 8, claim numbers only or hypertext links may be used to conserve display screen space. In another example, an expanded or detailed view may include some or all of the text for a particular field. In the example illustrated in FIG. 8, each claim may be grouped by claim sets 804, organized by when a claim was filed, and include a status of the claim or claim set. Information about related claims may be organized, for example, to include an amendment status 806, an examination status 808, related art cited 810, reasons for an Patent and Trademark Office Examiner's position 812, and any arguments by the applicant 814. In addition, in some example embodiments, additional claim sets and related information are displayed and described in the same display. In an embodiment, the examination status 808 includes allowed, rejected, unamended, or objected to.

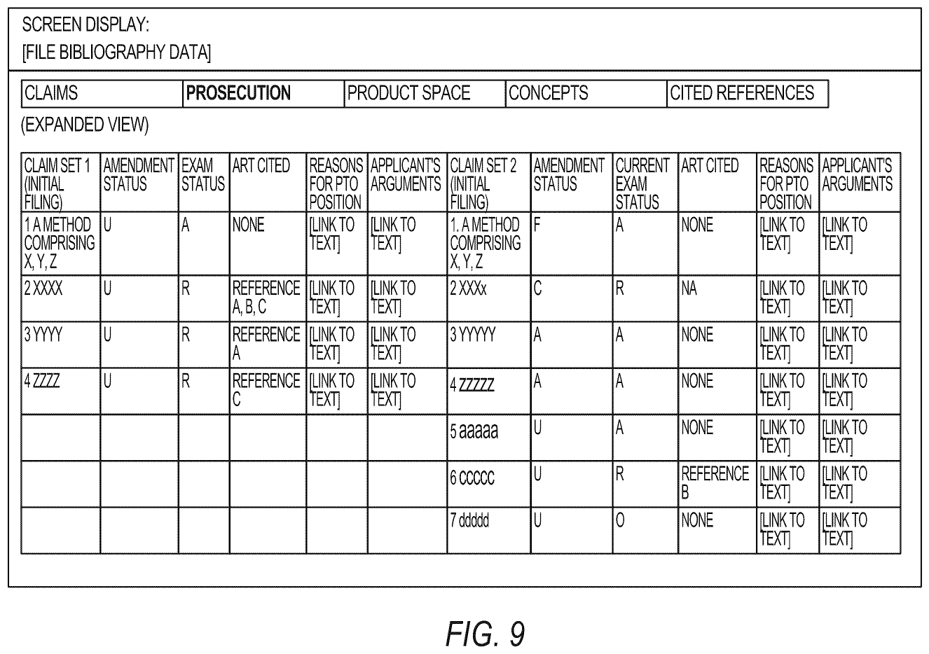

FIG. 9 is a display screen illustrating an example embodiment of a matter child node 106 and a prosecution grandchild node 118. FIG. 9 is an example of an expanded or detailed view of the information provided in FIG. 8. For example, claims, represented by their claim number in the collapsed view illustrated in FIG. 8, are displayed in some or all of the text of the claim in the expanded or detailed view in FIG. 9.

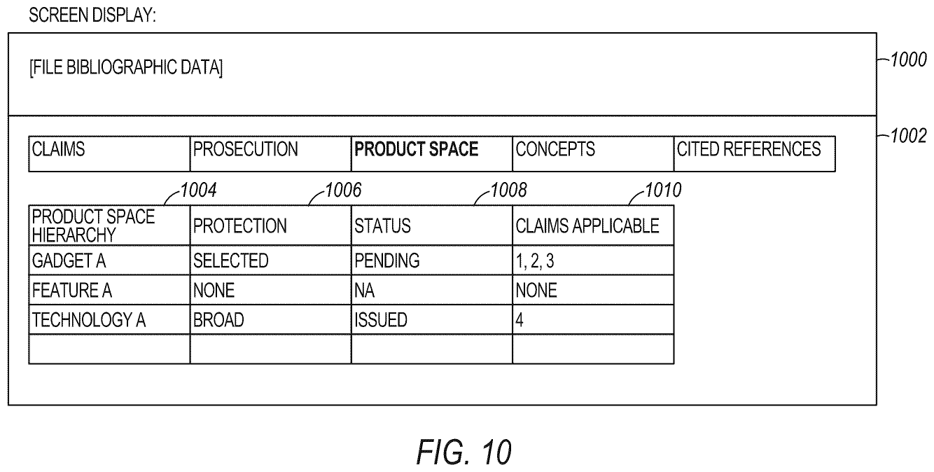

FIG. 10 is a display screen illustrating an example embodiment of a matter child node 106 and a product space grandchild node 120. In FIG. 10, the displayed content may be arranged in the content area 206, as described in FIG. 2, or alternatively, the displayed content may be provided on a new web page or display. In FIG. 10, the content is arranged into two areas, a matter information area 1000 and a matter specific content area 1002. In an embodiment, the matter information area 1000 is a frame in HTML and remains static while the user navigates the matter specific information in the matter specific content area 1002. The matter specific information illustrated in FIG. 10 includes information about related product space. In the example illustrated in FIG. 10, each product space 1004 may include attributes, such as an indicia of protection 1006, a status 1008, and related claims 1010. In an embodiment, the indicia of protection 1006 may include selected, none, or broad. In an embodiment, the status 1008 may include pending, issued, or not applicable (NA). In various embodiments, related claims 1010 may be listed by claim number or an indicia of a claim set and a claim number.

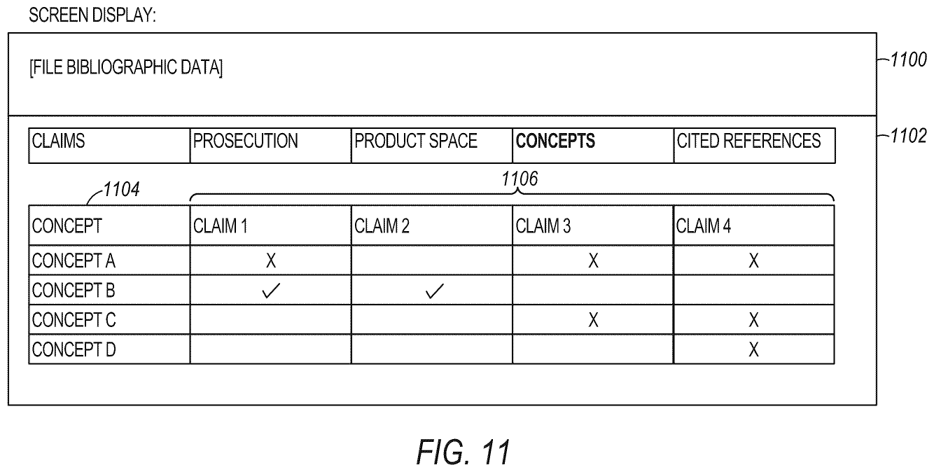

FIG. 11 is a display screen illustrating an example embodiment of a matter child node 106 and a concepts grandchild node 122. In FIG. 11, the displayed content may be arranged in the content area 206, as described in FIG. 2, or alternatively, the displayed content may be provided on a new web page or display. In FIG. 11, the content is arranged into two areas, a matter information area 1100 and a matter specific content area 1102. In an embodiment, the matter information area 1100 is a frame in HTML and remains static while the user navigates the matter specific information in the matter specific content area 1102. The matter specific information illustrated in FIG. 11 includes information about concepts related to the matter. In the example illustrated in FIG. 11, each concept 1104 may include one or more related claims 1106. In an embodiment, if a concept 1104 exists in a claim 1106, then an indicia, such as a check mark or an “x,” is provided in the intersecting portion of the table.

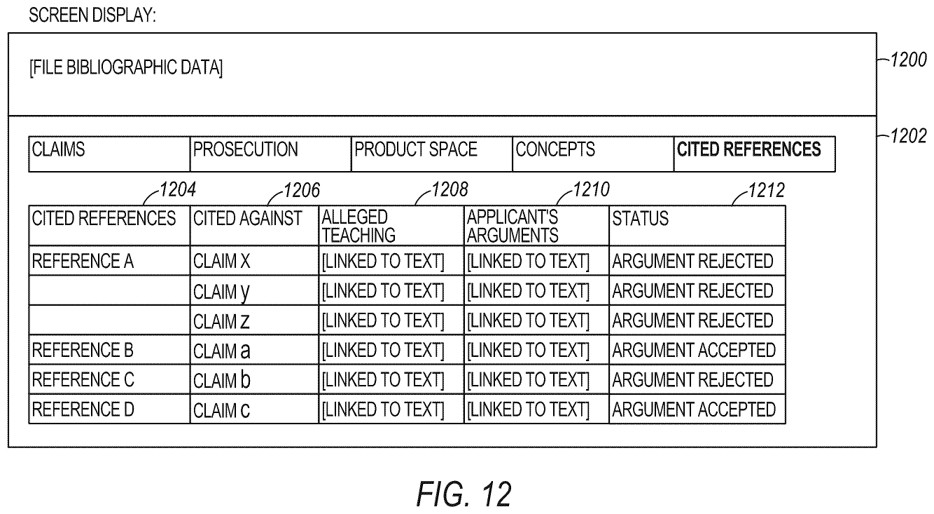

FIG. 12 is a display screen illustrating an example embodiment of a matter child node 106 and a cited references grandchild node 124. In FIG. 12, the displayed content may be arranged in the content area 206, as described in FIG. 2, or alternatively, the displayed content may be provided on a new web page or display. In FIG. 12, the content is arranged into two areas, a matter information area 1200 and a matter specific content area 1202. In an embodiment, the matter information area 1200 is a frame in HTML and remains static while the user navigates the matter specific information in the matter specific content area 1202. The matter specific information illustrated in FIG. 12 includes information about cited references related to the matter. In the example illustrated in FIG. 12, each cited reference 1204 may include one or more related claims 1206, an alleged teaching 1208 related to each claim 1206, an applicant's argument 1210, and a status 1212. In an embodiment, a status may include an indicia that the applicant's argument was rejected, accepted, declared moot, or is pending.

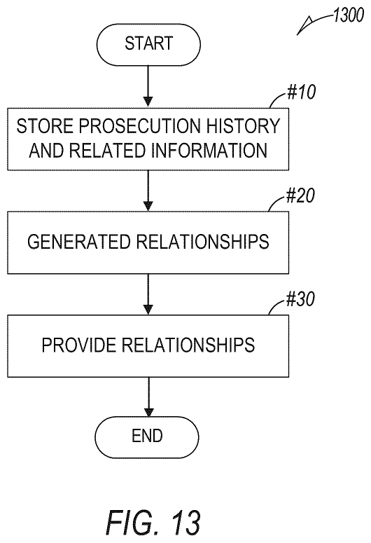

FIG. 13 is a flowchart illustrating a method 1300 of cataloging and providing intellectual property information, in accordance with an example embodiment. At 1302, information is collected and stored. Information may include data related to a patent portfolio, such as concepts, products, product spaces, patents, references, and the like. Information may also include prosecution history related to the patents or references. At 1304, relationships are generated. Relationships may include mappings between a claim and a reference, a claim and a concept, or the like. At 1306, one or more of the relationships are provided. In an embodiment, the relationships are provided using a graphical user interface, such as a web browser.

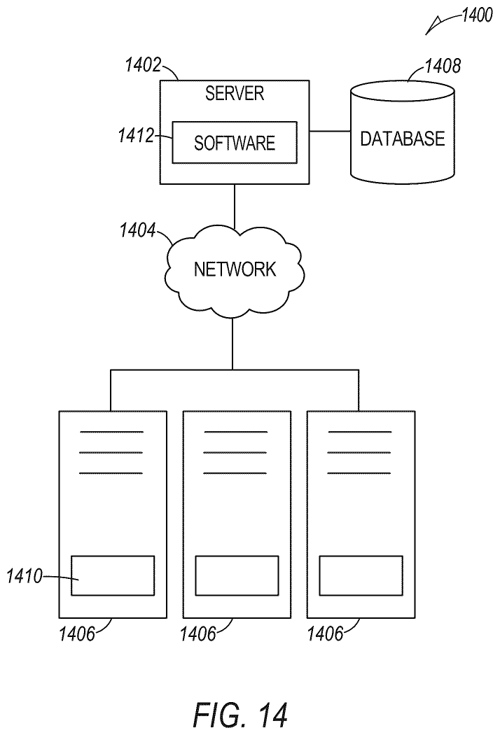

FIG. 14 is a diagram illustrating a client-server networked environment 1400, in accordance with an example embodiment. Embodiments of the inventive subject matter may find application in many different types of computer-based or network-based facilities or systems. Accordingly, the example embodiment is not intended to limit the scope of the inventive subject matter solely to such systems.

In an embodiment, the client-server networked environment 1400 includes a web server 1402, which can communicate over a network 1404 to a client computer 1406. The web server 1402 additionally can communicate using one or more direct or networked connections with other servers, such as an application server (not shown), an email server (not shown), and a database management server (not shown). In addition, a database 1408 is communicatively coupled to the network 1404.

In an embodiment, the client-server networked environment 1400 is accessed by a client program, for example a browser 1410 (e.g., Internet Explorer distributed by Microsoft Corp. of Redmond, Washington) that executes on the client computer 1406 and accesses the web server 1402 via the network 1404. In various embodiments, the network 1404 may include the Internet, a wide area network (WAN), a local area network (LAN), a wireless network (e.g., a cellular network), the Public Switched Telephone Network (PSTN) network, or the like.

In an embodiment, the web server 1402 uses software 1412 to receive a request from a client computer 1406, where in response to the request, the web server 1402 accesses the database 1408 and provides information to the client computer 1406. The information may include intellectual property information, as described above.

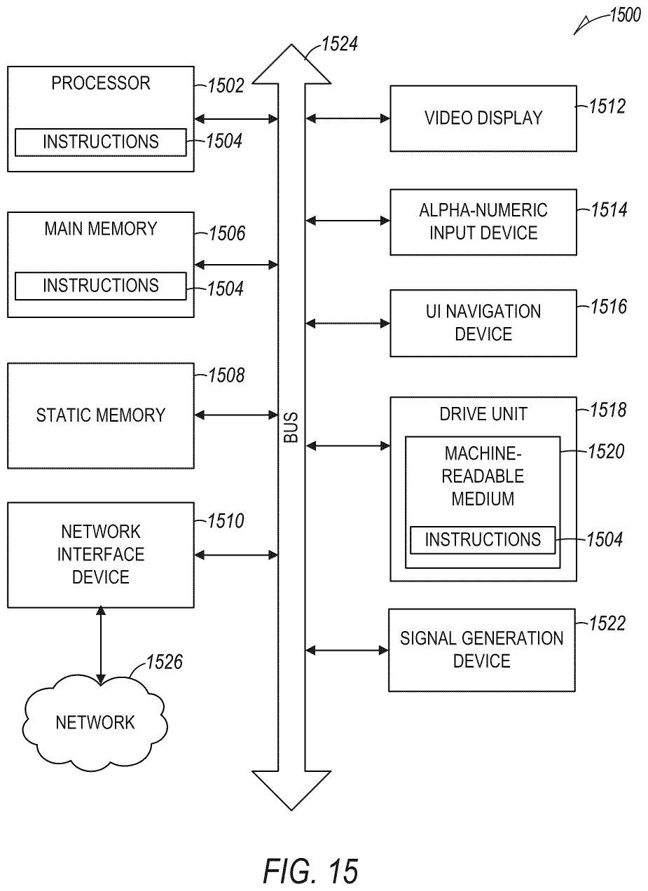

FIG. 15 is a block diagram illustrating a machine in the example form of a computer system 1500, within which a set or sequence of instructions for causing the machine to perform any one of the methodologies discussed herein may be executed. In alternative embodiments, the machine may comprise a computer, a network router, a network switch, a network bridge, Personal Digital Assistant (PDA), a cellular telephone, a web appliance, set-top box (STB) or any machine capable of executing a sequence of instructions that specify actions to be taken by that machine.

The computer system 1500 includes a processor 1502, a main memory 1504 and a static memory 1506, which communicate with each other via a bus 608. The computer system 1500 may further include a video display unit 1510 (e.g., a liquid crystal display (LCD) or a cathode ray tube (CRT)). The computer system 1500 also includes an alphanumeric input device 1512 (e.g., a keyboard), a cursor control device 1514 (e. g., a mouse), a disk drive unit 1516, a signal generation device 1518 (e.g., a speaker) and a network interface device 1520 to interface the computer system to a network 1522.

The disk drive unit 1516 includes a machine-readable medium 1524 on which is stored a set of instructions or software 1526 embodying any one, or all, of the methodologies described herein. The software 1526 is also shown to reside, completely or at least partially, within the main memory 1504 and/or within the processor 1502. The software 1526 may further be transmitted or received via the network interface device 1520. For the purposes of this specification, the term “machine-readable medium” shall be taken to include any medium which is capable of storing or encoding a sequence of instructions for execution by the machine and that cause the machine to perform any one of the methodologies of the inventive subject matter. The term “machine-readable medium” shall accordingly be taken to include, but not be limited to, solid-state memories, optical and magnetic disks, and carrier wave signals. Further, while the software is shown in FIG. 15 to reside within a single device, it will be appreciated that the software could be distributed across multiple machines or storage media, which may include the machine-readable medium.

The foregoing description of specific embodiments reveals the general nature of the inventive subject matter sufficiently that others can, by applying current knowledge, readily modify and/or adapt it for various applications without departing from the generic concept. Therefore, such adaptations and modifications are within the meaning and range of equivalents of the disclosed embodiments. The phraseology or terminology employed herein is for the purpose of description and not of limitation. Accordingly, the inventive subject matter embraces all such alternatives, modifications, equivalents and variations as fall within the spirit and broad scope of the appended claims.

Method embodiments described herein may be computer-implemented. Some embodiments may include computer-readable media encoded with a computer program (e.g., software), which includes instructions operable to cause an electronic device to perform methods of various embodiments. A software implementation (or method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMS), read only memories (ROMs), and the like.

It is to be understood that the above description is intended to be illustrative and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. § 1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A system comprising software executing on a computing platform for displaying relationships between various domains of IP information selected from the group of claims, prosecution history, products, concepts or art.

2. A method comprising tracking and displaying relationships between various domains of IP information selected from the group of claims, prosecution history, products, concepts or art.
